(19) United States
(12) Patent Application Publication
(10) Pub. No.: US 2005/0246065 A1
(43) Pub. Date: Nov. 3, 2005

(54) Volumetric sensor for mobile robotics

(76) Inventor: Benoit Ricard, St-Augustin-de-Desmaures (CA)

Correspondence Address: STITES & HARBISON PLLC, 1199 NORTH FAIRFAX STREET, SUITE 900, ALEXANDRIA, VA, 22314, US

(21) Appl. No.: 11/120,188

(22) Filed: May 3, 2005

Related U.S. Application Data
(60) Provisional application No. 60/566,941, filed on May 3, 2004.

(51) Int. Cl. G06F 19/00

(52) U.S. Cl. 700/258; 700/245

(57) ABSTRACT

A volumetric sensor for mobile robot navigation to avoid obstacles in the robot's path includes a laser volumetric sensor on a platform with a laser and detector directed to a tiltable mirror in a cylinder that is rotatable through 360° by a motor, a rotatable cam in the cylinder tilts the mirror to provide a laser scan and distance measurements of obstacles near the robot. A stereo camera is held by the platform, that camera being rotatable by a motor to provide distance measurements to more remote objects.

This claims benefit of Provisional Application Ser. No. 60/566,941 filed on 3 May 2004.

### FIELD OF THE INVENTION

The present invention relates to a multi sensor system for 3D mobile robot navigation, localization and mapping that combine a high-repetition rate laser range sensor and a stereo camera.

### BACKGROUND OF THE INVENTION

Currently, mobile robots are lacking in good peripheral vision to detect and track obstacles or plan paths in crowded or complex environments. One of the best ways to accurately sense the environment around the robot is by using laser ranging (lidar). Some lidars could be found on the market, but if they provide mapping in 3D, they are big, use lots of power and are expensive. Smaller ones provide only line scans on limited angular range (max 180° around the platform) resulting in limited view of the scene. Mobile robots moving in complex terrains need to track landmarks and obstacle all around the platform for navigation purpose.

Lars S. Nyland (IEEE Proceedings, 1998) in an article entitled Captured Dense Environmental Range Information with a Panning Scanning Laser Range Finder describes a laser range finder that uses a rotating mirror tilted at 45° that allows for range measurement in a 300° sweep and includes a digital camera where, after an environment is scanned, the laser is removed from the panning unit and replaced with the camera. The apparatus described by Lars S. Nyland obtains full-color images of a scene augmented with range data on a pixel-by-pixel basis. The apparatus described by Lars S. Nyland is built from an assembly of two commercial products (an Acquity Research AR-4000 ranging laser and a Dperception pan and titlt unit. To obtain the final result, the process requires removing the ranging laser and replacing it by a camera. The scanning process is slow.

### SUMMARY OF THE INVENTION

It is an object of the present invention to provide a navigation system for mobile robots with laser volumetric sensing to provide 3D ranging and imaging on 360° around a mobile platform.

A volumetric sensor for mobile robot navigation to avoid obstacles in the robot's path comprises a laser volumetric sensor mounted on a platform with a laser and detector directed to a tiltable mirror in the transparent cylinder that is rotatable through 360° by a motor, the mirror being tiltable by a rotatable cam mechanism in the transparent cylinder driven by a motor to provide a laser scan and distance measurements of obstacles near the robot.

### BRIEF DESCRIPTION OF THE DRAWINGS

The invention will be described in more detail with reference to the accompanying drawings in which:

FIG. 1 is a perspective view, partially cut away, of a scanning mechanism according to the present invention.

FIG. 2 is a perspective view of a scanning mechanism according to the present invention, which is mounted on a rotating platform along with a stereo camera.

### DESCRIPTION OF A PREFERRED EMBODIMENT

Currently, mobile robots are lacking in good peripheral vision to detect and track obstacles or plan paths in crowded or complex environments. One of the best ways to accurately sense the environment around the robot is by using laser ranging (lidar). Some lidars could be found on the market, but if they provide mapping in 3D, they are big, use lots of power and are expensive. Smaller ones provide only line scans on limited angular range (max 180° around the platform) resulting in limited view of the scene. Mobile robots moving in complex terrains need to track landmarks and obstacle all around the platform for navigation purpose.

Lars S. Nyland (IEEE Proceedings, 1998) in an article entitled Captured Dense Environmental Range Information with a Panning Scanning Laser Range Finder describes a laser range finder that uses a rotating mirror tilted at 45° that allows for range measurement in a 300° sweep and includes a digital camera where, after an environment is scanned, the laser is removed from the panning unit and replaced with a digital camera. The apparatus described by Lars S. Nyland obtains full-color images of a scene augmented with range data on a pixel-by-pixel basis but the images and range data are obtained at separate times.

The present invention uses a simple and sturdy mechanism to provide 3D ranging and imaging on 360° around a mobile platform located on a movable robot. This scanner provides good close range volumetric sensing (up to 10 m). To provide longer range data, the scanner is combined with a large baseline near IR stereo camera to track distant objects in 3D. Data from the scanner and the stereo camera are fused and provided to the robot's navigation, localization and mapping layer.

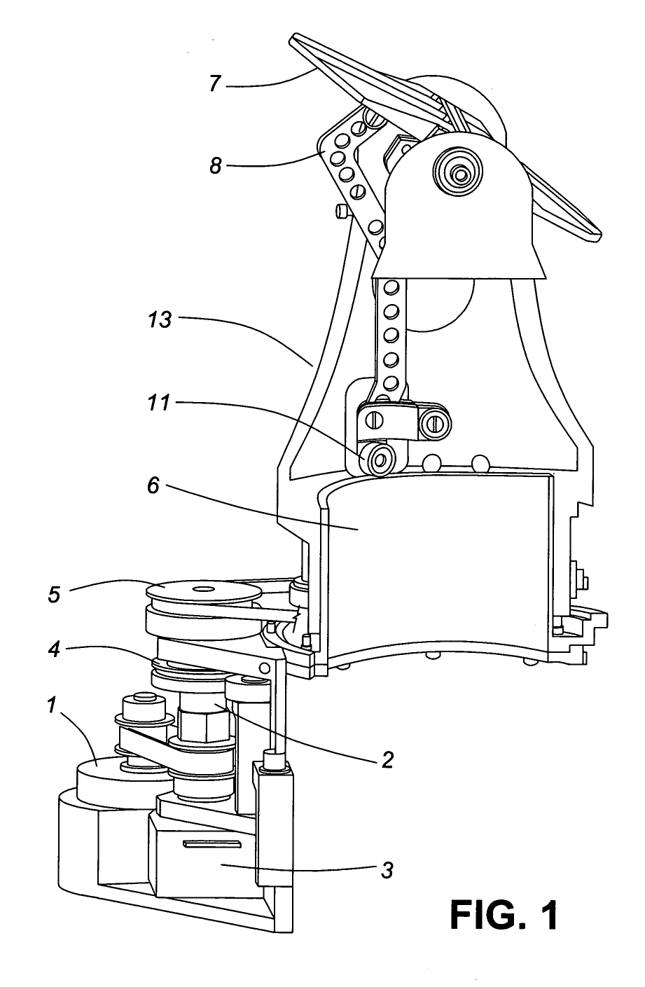

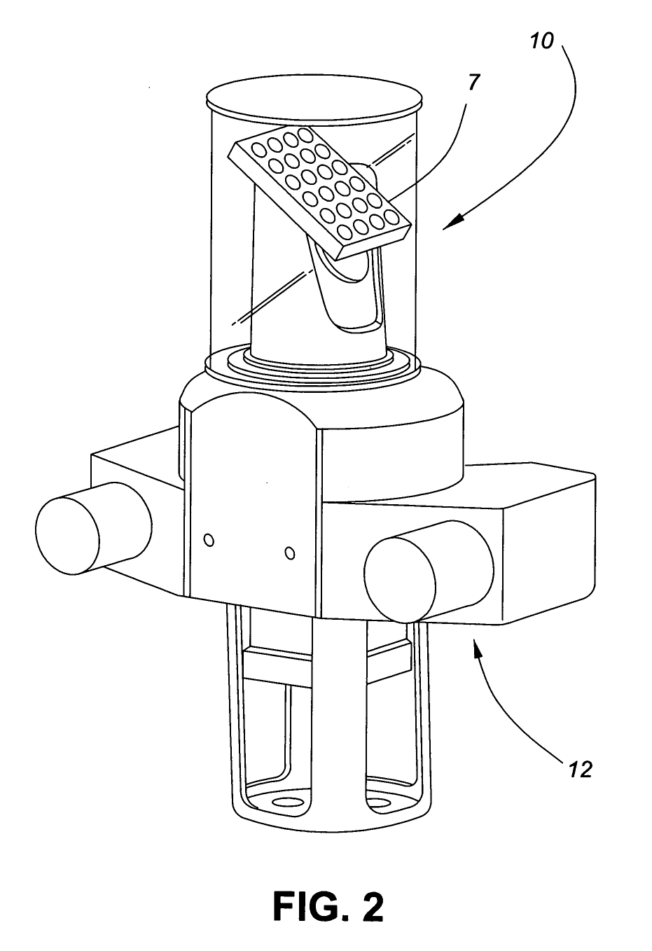

Referring to FIG. 1, the scanning mechanism works as follows: A small electrical motor 1 drives two concentric hollow cylinders. The external cylinder 10 (see FIG. 2) holds a mirror 7. The top edge of the internal cylinder has a cam pathway 6, which control the tilt angle of the mirror 7.

The azimuth and elevation axes are self-synchronized by the driving mechanism. The motor drives 40 and 38 tooth gears on the same driving shaft 2. The 40 tooth gear drives the rotation of the mirror cylinder 10 and the 38 tooth gear drives the cam cylinder 6. When the mirror cylinder is ending 40 revolutions, the cam cylinder 6 will complete 38 turns, resulting in one full elevation scan for each 10 revolutions of the mirror.

The laser beam is steered by a single mirror 7 mounted on a fork 13 rotating continuously at a speed near 1800 RPM and tilted up and down 90 times a minute. Both motions of the mirror are synchronized together and are driven by a single motor. The result is a screw-like scanning pattern ranging from minus 45° to plus 10° providing a range to nearby obstacles all around the robot.

The volumetric laser scanner illustrated in FIGS. 1 and 2 provides a mobile platform with 3D data of its environment around a mobile robot using laser ranging (lidar) and a stereo camera 12 (see FIG. 2). The scanner uses a laser range sensor to scan 360° around its vertical axis and vertically from −45° to +10° without obstruction. The tilting mirror is held on a fork 13 over the ranging laser sensor having a laser source and detector. The azimutal and vertical scanning are mechanically synchronized with only one motor driving the scan. The device provides a full volume scan around the platform up to 3 times a second. The data provided by the scanner is a 3D points cloud. Although a single motor was used for the laser scanner, the stereo camera may be steered around by a second motor with the camera being fixed to the platform and the second motor rotating the platform. All parts of this scanner were enclosed in a waterproof enclosure.

The motor 1 in FIGS. 1 and 2 drives a shaft 2 via a belt. There is an encoder 3 mounted on shaft 2 as well as a 38 tooth gear (4) and a 40 tooth gear (5). The 40 tooth gear drives a transparent cylinder 10 around mirror 7 and the 38 tooth gear drives the cam (6) in an inner cylinder that pushes up and down the tilt mechanism 8 and roller 11 for the tiltable mirror. By the time the mirror rotates 40 turns, the mirror will oscillate twice (2 times upward and 2 times downward). In other words, a full scan (from −45° to +10°) will be performed in 10 mirror rotations leading to a spiral motion with a step angle of 5.5 degrees.

The wide base stereo camera 12 and scanning lidar concept according to the present invention is illustrated in FIG. 2. The laser provides short range, precision measurements around the rotating platform whereas the stereo camera locates and tracks distant obstacles.

The prototype sensor has the following specification:
Weight: 4.5 kg
Height excluding feet: 320 mm
Body diameter: 180 mm
Near IR stereo camera
   Camera resolution: 1024×1024
   FOV: 35° (head rotates 360°)
   Base line: 250 mm
   Depth error (resolution) at 80 m: 1 m
   Stereo update: 1 Hz
Lidar Scanner
   Azimuth: 360° at up to 1200 rpm
   Elevation: −45° to 10° (120 rpm)
   Vertical pitch: 5.5° or 2.75°
   Up to 50,000 ranges per second
   Dept error (resolution) at 10 m: 5 mm
      This volumetric sensor will be referenced to the world by an inertial unit.

The present invention has sturdy mechanics to provide laser volumetric sensing around 360° and stereo vision on the same platform. The lidar provides short range precision measurements around the platform on which it is mounted and the stereo camera locates and tracks more distant objects.

Various modifications may be made to the preferred embodiment without departing from the spirit and scope of the invention as defined in the appended claims.

1. A volumetric sensor for mobile robot navigation to avoid obstacles in the robot's path comprises a laser volumetric sensor mounted on a platform with a laser and detector directed to a tiltable mirror in a first transparent cylinder that is rotatable through 360° by a motor, the mirror being tiltable by a rotatable cam mechanism in said first transparent cylinder driven by a motor to provide a laser scan and distance measurements of obstacles near the robot.

2. A volumetric sensor as defined in claim 1, wherein a stereo camera is held by the platform to provide distance measurements to more distant objects around the robot.

3. A volumetric sensor as defined in claim 2, wherein the stereo camera is a near infrared stereo camera with a depth resolution at 80 m of 1 m.

4. A volumetric sensor as defined in claim 3, wherein the laser scan has a depth resolution of 5 mm at 10 m.

5. A volumetric sensor as defined in claim 1, wherein a single motor rotates a shaft which is provided with an encoder, the shaft being connected to rotate the tiltable mirror through 360° via a first gear and connected to a second cylinder having a cam edge via a second gear to rotate that cam to tilt the mirror up and down via a cam mechanims.

6. A volumetric sensor as defined in claim 5, wherein the first gear has 40 tooth and said second gear has 38 tooth with the tilting of the mirror being synchronized with the rotation of the mirror.

7. A volumetric sensor as defined in claim 3, wherein the platform is rotated by a second motor to rotate the stereo camera.

8. A volumetric sensor as defined in claim 5, wherein the tiltable mirror is supported in the first transparent cylinder by a fork that allows the mirror to be tilted by said cam edge on said second cylinder and by a cam mechanism.

9. A volumetric sensor as defined in claim 2, wherein the stereo camera has a base line of 250 mm.

10. A volumetric sensor as defined in claim 2, wherein data from the laser scan and data from the stereo camera are fused and provided to a robot's navigation, localization and mapping layer.

11. A volumetric sensor as defined in claim 1, wherein the mirror is tiltable about its axis from −45° to +10°.

12. A volumetric sensor as defined in claim 5, wherein the mirror is tiltable about its axis from −45° to +10°.

13. A volumetric sensor as defined in claim 10, wherein the mirror is tiltable about its axis from −45° to +10°.

14. A volumetric sensor as defined in claim 8, wherein the mirror is tiltable about its axis from −45° to +10°.

15. A volumetric sensor for mobile robot navigation to avoid obstacles in the robot's path comprises a laser volumetric sensor on a platform directed to a tiltable mirror supported by a fork that allows the mirror to be tiltable by a rotatable cam edge on a cylinder rotated by a motor and a cam mechanism, the motor rotating the fork through 360°.

16. A volumetric sensor as defined in claim 15, wherein the mirror is tiltable about it axis from −45° to +10°.

17. A volumetric sensor as defined in claim 16, wherein a stereo camera is held by the platform to provide distance measurements to more distant object around the robot, the platform being rotatable by a second motor.

18. A volumetric sensor for mobile robot navigation to avoid obstacles in the robot's path comprises a laser volumetric sensor mounted on a platform with a laser and detector directed to a tiltable mirror supported by a fork in a transparent cylinder, the fork being rotatable through 360° by a motor, the mirror being tiltable by a rotatable cam mechanism in the transparent cylinder driven by the motor to provide a laser scan and distance measurements of obstacles near the robot.

19. A volumetric sensor as defined in claim 18, wherein the motor rotates a shaft which is provided with an encoder, the shaft being connected to rotate the fork through 360° via a first gear and connected to the rotatable cam mechanism via a second gear to tilt the mirror up and down via a cam mechanism.

20. A volumetric sensor as defined in claim 19, wherein the first gear and second gear have a different number of teeth with the tilting of the mirror being synchronized with the rotation of the mirror.
